(19) United States
(12) Patent Application Publication
(10) Pub. No.: US 2015/0075393 A1
(43) Pub. Date: Mar. 19, 2015

(54) TRASH CAN ASSEMBLY

(71) Applicants: Wei-Teh Ho, Taipei (TW); Willy Ho, Taipei (TW)

(72) Inventors: Wei-Teh Ho, Taipei (TW); Willy Ho, Taipei (TW)

(21) Appl. No.: 14/030,902

(22) Filed: Sep. 18, 2013

(51) Int. Cl. B65F 1/14

(52) U.S. Cl. CPC B65F 1/1405
USPC 100/245

(57) ABSTRACT

A trash providing a lid with a compressable structure manually operable via a handle bar adjustably attached to the lid is described. The compressable structure can allow the volume of contents stored within the trash can to be compressed for more efficient use of garbage bags. The handle bar may be attached to the lid in a storage position when not in use. Alternatively or optionally, the handle bar may be attached to the lid in an operating position to push compacting the compressable structure or to pull opening the lid. The handle bar by be operable between the operating and storage position via simple manual push, pull and/or rotate actions.

### FIELD OF INVENTION

The present invention relates generally to waste containers, and in particular, to a trash can assembly convenient for compacting trash.

### BACKGROUND

Trash containers are well-known devices used to dispose of various kinds of waste. There is a need to reduce the size of waste in a trash container (e.g., to compact or compress the waste) before the waste is disposed. Compacting allows more waste to be disposed of before the trash container is emptied to reduce the number of trash bags used.

Examples of devices for compacting trash include electrical devices based on motors or even us hydraulic systems. Other devices typically preferred for home or office use may have levers, baffles, numerous moving parts, or cumbersome components.

Even though existing devices may be effective, users continually seek easier, simpler and more cost effective ways to compact trash in a container for disposal.

### SUMMARY OF THE DESCRIPTION

A trash can provides a lid with a compressing structure manually operable via a handle bar adjustably attached to the lid. The compressing structure can allow the volume of contents stored within the trash can to be compressed for more efficient use of garbage bags. The handle bar may be attached to the lid in a storage position when not in use. Alternatively or optionally, the handle bar may be attached to the lid in an operating position to push the compressing structure or to pull opening the lid. The handle bar by be operable between the operating and storage position via simple manual push, pull and/or rotate actions.

Other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

The present invention is illustrated by way of examples and not limitations in the figures of the accompanying drawings, in which like references indicate similar elements and in which:

FIGS. 1A-1B are perspective views of a trash can assembly according to some embodiments of the present invention;

FIG. 2 is an exploded view of a trash can assembly according to one embodiment of the present invention;

FIGS. 3A-3E show an exemplary sequence of operation for a trash can assembly according to one embodiment of the present invention;

FIG. 4 shows exemplary configurations to operate a trash can assembly according to one embodiment of the present invention.

### DETAILED DESCRIPTION

In the following description, numerous specific details are set forth, such as examples of external surfaces, named components, connections between components, etc., in order to provide a thorough understanding of the present invention. It will be apparent, however, to one skilled in the art that the present invention may be practiced without these specific details. In other instances, well known components or methods have not been described in detail but rather in a block diagram in order to avoid unnecessarily obscuring the present invention. Further specific numeric references such as first, second, third, etc., may be made. However, the specific numeric references should not be interpreted as a literal sequential order but rather interpreted as references to different objects. Thus, the specific details set forth are merely exemplary. The specific details may be varied from and still be contemplated to be within the spirit and scope of the present invention.

Reference in the specification to “one embodiment” or “an embodiment” means that a particular feature, structure, or characteristic described in connection with the embodiment can be included in at least one embodiment of the invention. The appearances of the phrase “in one embodiment” in various places in the specification do not necessarily all refer to the same embodiment.

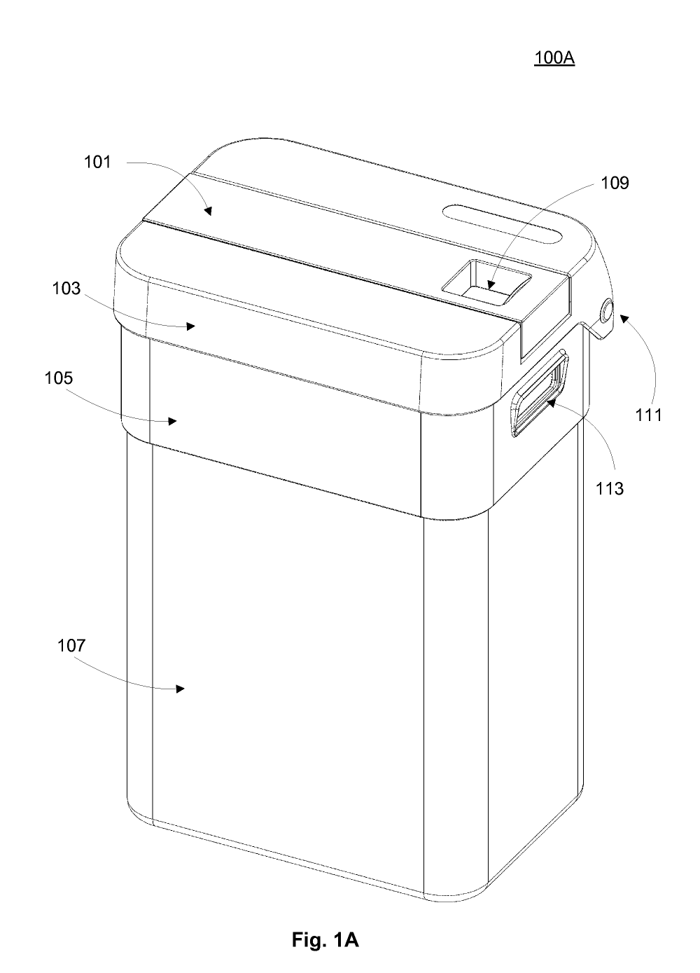

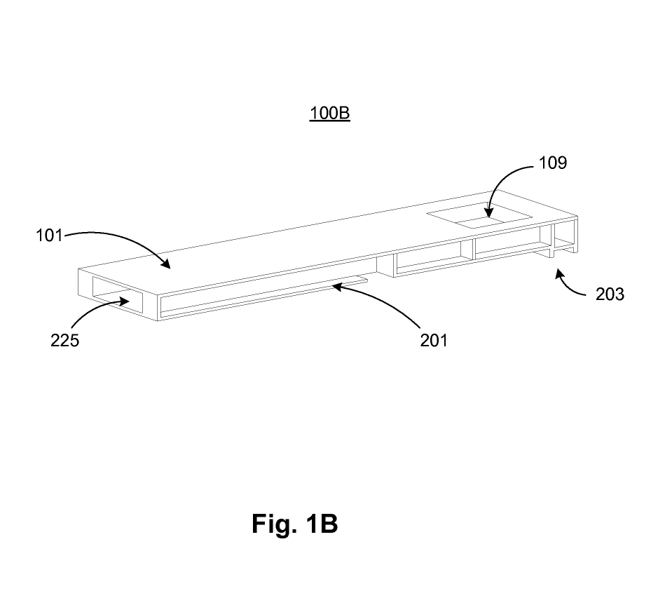

FIGS. 1A-1B are perspective views of a trash can assembly according to some embodiments of the present invention. Assembly 100A can include container body 107 defining a chamber with an open end. Container body 107 may be shaped in a rectangular form, a circular form, an oval form, or other applicable forms. In one embodiment container body 107 may include outer container casing with handle openings 113 to facilitate hand carriage.

Assembly 100A may include lid 103 hingedly coupled with container body 107, for example, via lid base 105. Lid 103 may be positioned close to the open end of container body 107. In one embodiment, lid base 105 may be attached to lid 103 via hinge mechanism 111 or other applicable mechanism to allow lid 103 to move opening or closing the open end of container body 107. Alternatively, lid 103 may be directly coupled with container body 107 without a separate lid base.

Lid 103 may include a handle bar or handle structure 101 movably attached with lid 103 to provide a versatile or multi-functional handle for a user to operate assembly 100. Handle structure 101 may be shaped as a bar, a rod, or other applicable longitudinal shape. In one embodiment, handle structure 101 may include pull out opening 109 to allow a user to operate assembly 100 by pushing/pulling handle structure 101.

According to certain embodiments, lid 103 may be configured with multiple receiving structures to accommodate handle structure 101. For example, handle structure 101 may be stored within lid 103 with a longitudinal direction substantially parallel to a surface plane of lid 103. During operation, handle structure 101 may be repositioned with its longitudinal direction substantially perpendicular to the surface plane of lid 103 to be either pulled to open lid 103 or pushed to compact inner chamber of container body 107.

Turning now to FIG. 1B, assembly 100B may include portions of assembly 100A of FIG. 1A. For example handle structure 101 may include front opening 225, one or more guide slots 201 on both sides. Stop structure 203 may be configured toward a longitudinal end opposite to front end 225.

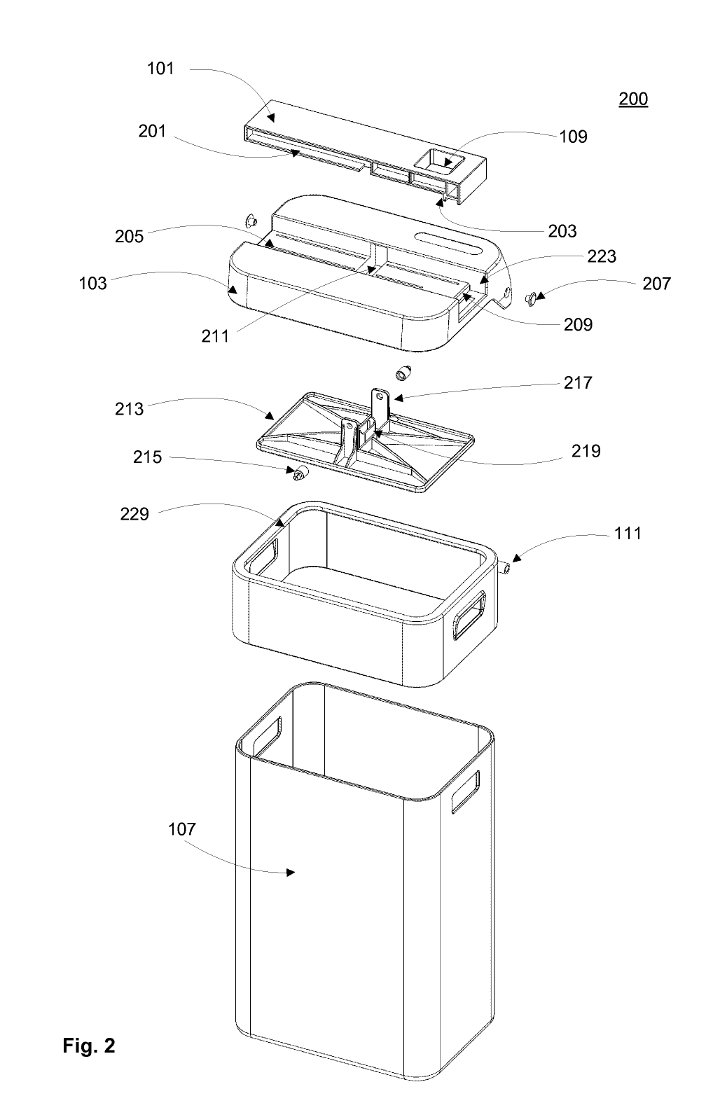

FIG. 2 is an exploded view of a trash can assembly according to one embodiment of the present invention as shown in FIG. 1. Assembly 200 may include lid 103 configured with multiple receiving structures for handle structure 101. For example, a horizontal recess 223 may be defined across the top portion of lid 103 for fittingly housing handle structure 101. Recess 223 may be shaped to match handle structure 101. For example, handle structure 101 may be longitudinally aligned with both ends of recess 223.

In one embodiment, a receiving structure may include central opening 211 sized to allow handle structure 101 to move in and out longitudinally for trash can operation. For example, central opening 211 may be sized to match a cross section dimension of handle structure 101 to allow one longitudinal end of handle structure 101 to move transversely across lid 103 via central opening 211. In some embodiments, recess 223 may include sliding tracks 205 to allow handle structure 101 to slide into or out of recess 223.

Assembly 200 may include compacting plate 213 coupled with handle structure 101 through central opening 211 of lid 103. Handle structure 101 may be operable to pull compacting plate 213 via central opening 211 to push open lid 103. Alternatively, handle structure 101 may be operable to push compacting plate 213 to compact the chamber of container body 107 via central opening 211.

In one embodiment, handle structure 101 may be configured with stop structure 203 towards one longitudinal end. Recess 223 (e.g. a receiving structure) may be shaped with a corresponding stop wall 209 matching stop structure 203. For example, handle structure 101 may be stopped when sliding into recess 223 via stop structure 203 to a secure position within lid 103.

In certain embodiments, compacting plate 213 and handle structure 101 may be coupled via one or more sliding pins 215 affixed over a back side of compacting plate 213. Handle structure 101 may include one or more longitudinal guide slots 201 to movably house sliding pins 215. Each sliding pin 215 may be movably constrained within one of the guide slots 210.

Compacting plate 213 may include one or more pull arms 217, e.g. substantially vertically standing, on its back side. Each sliding pin 215 may be affixed towards the tip of one of pull arms 217. For example, two sliding pins 215 may be positioned in between a pair of pull arms 217. In one embodiment, pull arms 217 may be sized to be insertable through central opening 211 to engage sliding pins 215 within guide slots 201 of handle structure 101. Guide slot 201 may be defined along handle structure 101 to extend between one longitudinal end (e.g. opposite to pull out opening 109) of handle structure 101 and a central portion (e.g. towards pull out opening 109). Compacting plate 219 may be vertically supported under lid 103 by hanging from handle structure 101 via sliding pins 215.

In one embodiment, handle structure 101 may be rotable to be received by lid 103 via recess 223 or central opening 211 when sliding pins 215 are engaged within guide slots 201 towards one end of handle structure 101. For example, handle structure 101 may be positioned with one end close to central opening 211 along recess 223 to allow rotating around an axis formed via sliding pins 215. As a result, handle structure 101 may be repositioned to be vertically or horizontally engaged with lid 103 (e.g. over a surface plane of lid 103).

When handle structure 101 is attached to lid 103 via central opening 211, pulling force exerted on handle structure 101 (e.g. via pull out opening 109) with sliding pins 215 engaged at the longitudinal end of guide slots 201 may cause compacting plate 213 to push open lid 103. Compacting plate 213 may include push protrusion 219 defined over its back side to receive a longitudinal end with front opening 225 of handle structure 101.

Pushing force exerted on handle structure 101 inserted through central opening 211 may cause compacting plate 213 to compress the chamber of container body 107 via push protrusion 219 engaged with front opening 225 of handle structure 101. Compacting plate 213 may be sized substantially conforming to the inner dimension of container body 107 to prohibit lid 103 from being opened when push protrude 219 is engaged with front opening 225 of handle structure 101.

In another embodiment, lid base 105 may have an opening at open end 229. Lid 103 may be hingedly coupled with lid base 105 adjacent to open end 229. Lid 103 can have horizontal receiving structure 223 and central opening 221 transversely defined across horizontal receiving structure 223. Handle bar 101 may be movably attached to lid 103 via horizontal receiving structure 223 or central opening 221. Compacting plate 213 may be coupled with handle bar 101 through central opening 211 of lid 103.

Handle bar 101 may be operable to pull open lid 103 or to push compacting plate 213 towards an opposite direction of open end 229 (e.g. downward). Handle bar 101 may be fittingly stored within horizontal receiving structure 223 of lid 103. Container body 107 may define a chamber. Lid base 103 may be attached on top of container body 107 with the chamber open towards open end 229 of lid base 103. The chamber of container body 107 may be compacted or compressed when compacting plate 213 is pushed via handle bar 101 through central opening 211.

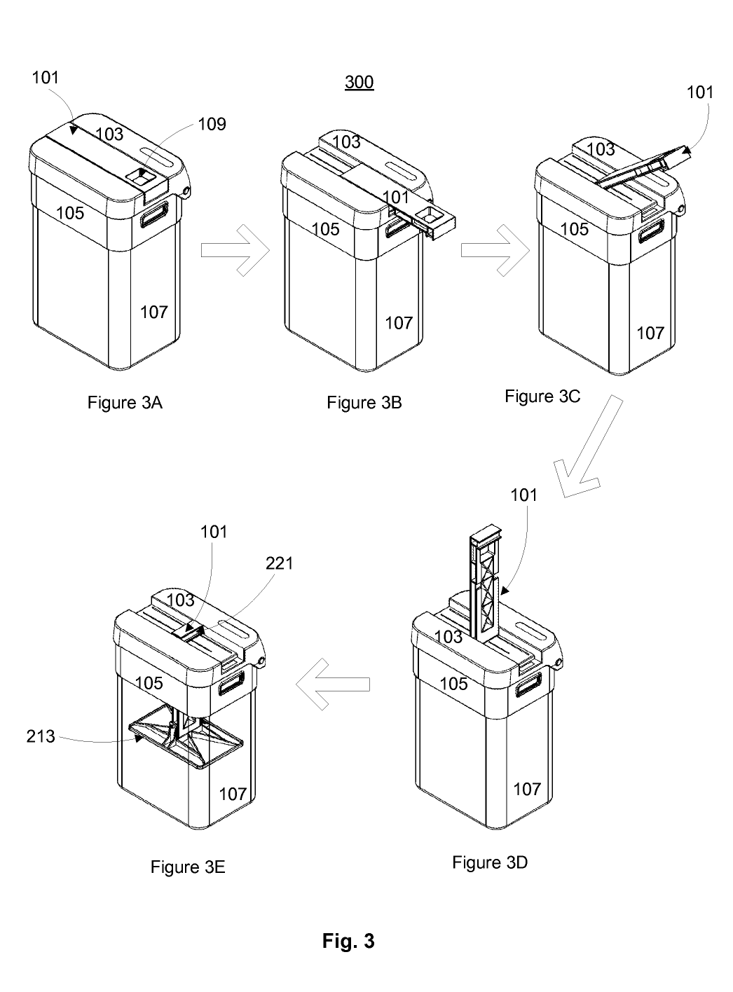

FIGS. 3A-3E show an exemplary sequence of operation for a trash can assembly according to one embodiment of the present invention, such as assembly 100 of FIG. 1. Sequence 300 may illustrate exemplary configurations of an assembly embodiment which may be operable in various other applicable sequences and/or configurations. Turning now to FIG. 3A, handle structure 101 may be stored seamlessly within a horizontal receiving structure of lid 103. In FIG. 3B, handle structure 101 may be pulled sliding out of lid 103 horizontally from a pull end (e.g. a longitudinal end close to pull out opening 109) until the other longitudinal end (or the far end) of handle structure 101 substantially aligned with central opening 211 of lid 103.

In FIG. 3C, central opening of lid 3 may allow handle structure 101 to be rotated with the pull end vertically away from the surface of lid 3. The rotation may be made possible with space provided via the central opening for an axis formed at the far end (or front end) of handle structure 101. Coupling mechanism between handle structure 101 and compacting place 213 may prohibit handle structure 101 from being rotatable if the front end of handle structure 101 is positioned at a location other than substantially close to central opening 211. In FIG. 3D, handle structure 101 may be positioned substantially perpendicular to the surface plane of lid 103 to be received into the central opening 221. When pushed, handle bar 101 may cause compacting plate 213 to compress storage chamber of container body 107 in FIG. 3E.

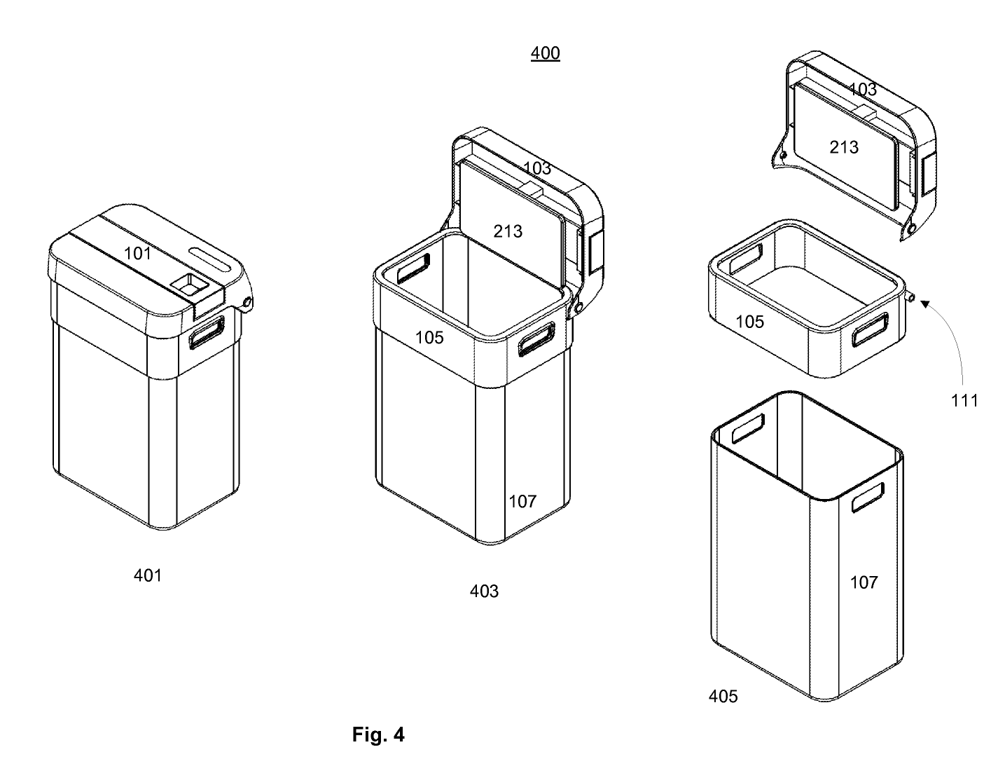

FIG. 4 shows exemplary configurations to operate a trash can assembly according to one embodiment of the present invention, such as assembly 100 of FIG. 1. For example, trash can assembly may be closed with handle structure 101 stored within lid 103 in configuration 401. Lid 103 may be opened with the front surface of compacting plate 213 affixed with the inner surface of lid 103 in configuration 403.

In one embodiment, lid 103 may be prohibited from being opened without handle structure 101 attached via specific positions to lid 103. For example, handle structure 101 may be attached to lid 103 to pull close compacting plate 213 with lid 103, such as in configuration 401, to allow lid 103 to be opened. Compacting plate 213 pushed down into the chamber of container 107 may prevent lid 103 from being opened. Configuration 405 shows lid 103, lid base 105 and container body 107 disassembled from each other.

Many modifications and other embodiments of the invention set forth herein will come to mind to one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A trash storage assembly comprising:
a container body defining a chamber with an open end;
a lid hingedly coupled with the container body adjacent to the open end, the lid having a plurality of receiving structures and a particular one of the receiving structures having a central opening in the lid;
a handle structure movably attached to the lid via one of the receiving structures; and
a compacting plate coupled with the handle structure through the central opening of the lid,
wherein the handle structure is operable to pull open the lid via the particular receiving structure, wherein the handle structure is operable to compact the chamber of the container body via the particular receiving structure and wherein the handle structure is fittingly storable within a separate one of the receiving structures of the lid.

2. The assembly of claim 1, wherein a longitudinal direction of the handle structure attached at the particular receiving structure is substantially perpendicular to a surface plane of the lid and wherein the longitudinal direction of the handle structure attached at the separate receiving structure is substantially parallel to the surface plane of the lid.

3. The assembly of claim 1, wherein the separate receiving structure includes one or more sliding tracks to allow the handle structure to slide into or out of the separate receiving structure longitudinally along the sliding tracks

4. The assembly of claim 1, wherein the handle structure and the separate receiving structure of the lid are capable of being longitudinally aligned along two longitudinal ends of the handle structure, wherein the handle structure includes a pull out opening towards one of the longitudinal ends to facilitate operating the handle structure.

5. The assembly of claim 4, wherein the handle structure is configured with a stop structure towards the one longitudinal end, wherein the separate receiving structure is shaped with a stop wall to allow stopping the handle structure via the stop structure when the handle structure is sliding into the separate receiving structure.

6. The assembly of claim 4, wherein the particular receiving structure is configured to fit with a cross section of the handle structure to allow a separate one of the longitudinal ends of the handle structure to move transversely across the lid via the central opening.

7. The assembly of claim 6, wherein the compacting plate is affixed with one or more sliding pins over a back side of the compacting plate, wherein the handle structure includes one or more longitudinal guide slots, and wherein each sliding pin is movably constrained within one of the guide slots for the coupling of the compacting plate and the handle structure.

8. The assembly of claim 7, wherein the compacting plate includes one or more pull arms over the back side of the compacting plate, wherein each sliding pin is affixed towards the tip of one of the pull arms, and wherein the pull arms are sized to be insertable through the central opening to engage the sliding pins within the guide slots.

9. The assembly of claim 7, wherein each guide slot extends from the separate longitudinal end of the handle structure, wherein the handle structure is rotable between the particular receiving structure and the separate receiving structure when the sliding pins are engaged within the guide slots at the separate longitudinal end.

10. The assembly of claim 9, wherein pulling force exerted on the handle structure attached at the particular structure causes the compacting plate to push open the lid via the sliding pins engaged at the separate longitudinal end of the guide slots.

11. The assembly of claim 7, wherein the compacting plate includes a push protrusion defined over the back side of the compacting plate, wherein the handle structure includes a front opening at the separate longitudinal end, and wherein pushing force exerted on the handle structure attached at the particular structure causes the compacting plate to compact the chamber of the container body via the push protrusion engaged with the front opening of the handle structure.

12. The assembly of claim 11, wherein compacting plate is sized substantially conforming the container body to prohibit the lid from being opened when the push protrusion is engaged with the front opening of the handle structure.

13. A trash storage assembly comprising:
a lid base defining an open end;
a lid hingedly coupled with the lid base adjacent to the open end, the lid having a horizontal receiving structure and a central opening transversely across the horizontal receiving structure;
a handle bar movably attached to the lid via the horizontal receiving structure or the central opening; and
a compacting plate coupled with the handle bar through the central opening of the lid,
wherein the handle bar is operably attached through the central opening to pull open the lid or to push the compacting plate towards an opposite direction to the open end, wherein the handle bar is fittingly storable within the horizontal receiving structure of the lid.

14. The assembly of claim 13, further comprising a container body defining a chamber, wherein the lid base is attached on top of the container body with the chamber open towards the open end and wherein the chamber is compacted when the compacting plate is pushed.
